(19) United States
(12) Patent Application Publication
(10) Pub. No.: US 2016/0192801 A1
(43) Pub. Date: Jul. 7, 2016

(54) CIRCULATOR COOKER

(71) Applicant: Jeff WU, Stafford, TX (US)

(72) Inventor: Jeff WU, Stafford, TX (US)

(21) Appl. No.: 14/987,265

(22) Filed: Jan. 4, 2016

Related U.S. Application Data
(60) Provisional application No. 62/099,396, filed on Jan. 2, 2015.

(51) Int. Cl. A47J 27/10

(52) U.S. Cl. CPC A47J 27/10; A23L 1/0121; A23V 2002/00

(57) ABSTRACT

Disclosed herein is a circulator cooker for sous-vide cooking. The circulator cooker can comprises an upper portion including a display device and a communication interface coupled to a controller and a lower portion partial immersed in a fluid of a fluid container and having a motor and heating element coupled to the motor. The controller of the circulator cooker can receive by the communication interface a temperature and in response to receiving the temperature actuates the motor and the heating element to heat the fluid of the fluid container to a constant temperature.

### CROSS-REFERENCE TO RELATED APPLICATION

This application claims priority to U.S. Provisional Application No. 62/099,396, filed on Jan. 2, 2015, the contents of each of the applications being hereby expressly incorporated herein by reference.

### FIELD OF TECHNOLOGY

The present disclosure relates generally to food cooking devices, and more specifically, to a precision temperature control water heater and water pump circulator appliance for cooking food in a water bath.

### BACKGROUND

Sous-vide is a method of cooking food sealed in airtight plastic bags in a water bath for longer than conventional cooking times at an accurately regulated temperature much lower than temperatures used for conventional cooking, typically around 55° C. (131° F.) to 60° C. (140° F.) for meats and higher for vegetables. Current sous-vide circulators tend to be designed like scientific equipment consisting of an AC motor above the water and shaft attached to a submersed impeller that agitates or pumps water.

### SUMMARY

Broadly speaking, this disclosure relates to sous-vide circulator cookers for home sous-vide cooking. The disclosed devices are particularly suited for use in home kitchens; however, the devices are not limited to home kitchens and can be used in commercial environments.

Disclosed herein is a circulator cooker for sous-vide cooking. The circulator cooker can comprise an upper portion including a display device and a communication interface coupled to a controller, and a lower portion partial immersed in a fluid of a fluid container and having a motor and heating element coupled to the motor. The controller of the circulator cooker can receive by the communication interface a temperature reading and in response to receiving the temperature reading can actuate the motor and the heating element to heat the fluid of the fluid container to a constant temperature.

In some embodiments, a circulator cooker for sous-vide cooking can include an upper portion including a controller, a display device, an input device and an audio output device (e.g., speaker/buzzer) coupled to the controller. The circulator cooker for sous-vide cooking can also include a middle portion connected to the upper portion, the middle portion housing a motor coupled to the controller and a lower portion connected to the middle portion, the lower portion housing a fluid agitation device coupled to the motor, a heating element coupled to the controller and configured for at least partial immersion in a fluid. In other embodiments, the circulator cooker for sous-vide cooking comprises only two portions: an upper portion and a lower portion. In other embodiments, the circulator cooker for sous-vide cooking comprises a single portion.

In some embodiments, a circulator cooker for sous-vide cooking can have one or more turn-able and/or rotatable information displays. In some embodiments, the information display can be tilted. The display can be located on the top of the device and can be configured to keep electronics housed therein protected from steam, water and heat and to enable easy viewing from a plurality of different angles.

In some embodiments, the circulator cooker can control a cooling system that enables the water bath to be used as a refrigeration device. In some embodiments, the circulator cooker can adjust its own motor speed (e.g., in response to a sensor reading, etc.). In some embodiments, a pump housing of the circulator cooker can also be attached with other attachments like nozzles and flow diffusers.

In some embodiments, the circulator cooker can include a wireless communication interface for communicating with remotely located device (e.g., a wireless temperature sensor, a pH meter, etc.). The wireless communication interface can also be configured to enable remote operation of the cooker.

In some embodiments, the display device of the circulator cooker of the can be touch-sensitive. In other embodiments, the display device can include capacitive touch pads to enable user interaction without the need for a full touch screen.

In some embodiments, a method of sous-vide cooking is disclosed. The method can include receiving a ready time and an indication food is present in a fluid of a container. The method can also include calculating a start time based on the ready time and a type of food. The method can further include transmitting to a cooling system, a control signal to cool the fluid of the container when the start time is not within a predetermined time. Finally, the method can include actuating, at the start time, a heater and an agitation device of the circulator cook.

### BRIEF DESCRIPTION OF THE DRAWINGS

In order to describe a manner in which features of the disclosure can be obtained, reference is made to specific embodiments that are illustrated in the appended drawings. Based on an understanding that these drawings depict only example embodiments of the disclosure and are not intended to be limiting of scope, the principles herein are described and explained with additional specificity and detail through the use of the accompanying drawings in which:

FIG. 1 illustrates an exploded view of an example circulator cooker;

FIG. 2A illustrates a side view of an example circulator cooker;

FIG. 2B illustrates a front view of an example circulator cooker;

FIG. 2C illustrates a side view of an example circulator cooker;

FIG. 2D illustrates a back view of an example circulator cooker;

FIG. 2E illustrates an angled view of an example circulator cooker;

FIG. 3 illustrates an example method of a circulator cooker and cooling system;

FIG. 4 illustrates an example control unit for a circulator cooker; and

FIG. 5 illustrates an example electronic device for controlling a circulator cooker.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the scope of the disclosure.

Several definitions that apply throughout this document will now be presented. “Circulating” means agitating, blending or mixing of one or more fluids. Hence a “circulator” is a device which can be configured to agitate, blend or mix a fluid. Fluids will be understood to comprise liquids. “Coupled” is defined as connected, whether directly or indirectly through intervening components and is not necessarily limited to physical connections. Coupled devices are devices which are in signal communication with one another. “Connected” means directly connected or indirectly connected.

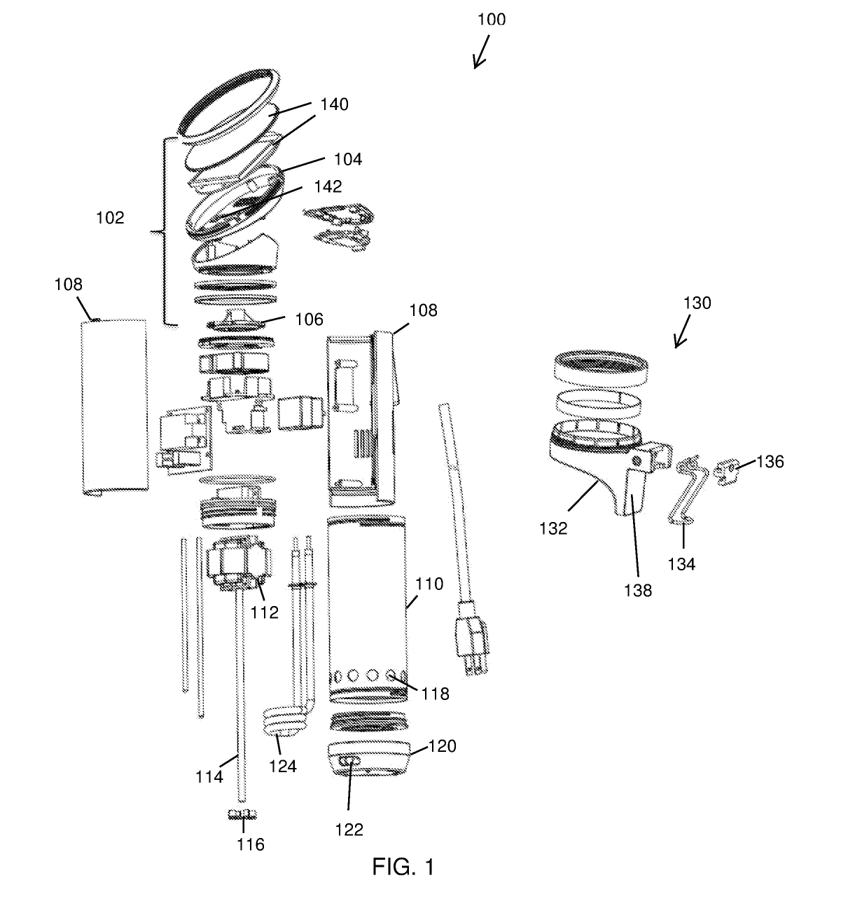

FIG. 1 illustrates an example circulator cooker 100. In some embodiments, circulator cooker 100 can comprise upper portion 102, middle portion 108 and lower portion 110. In at least one embodiment, circulator cooker 100 can include two portions: an upper portion and a lower portion. In at least one embodiment, circulator cooker 100 can include one portion. In at least one embodiment, a circulator cooker can include one or more portions. In some embodiments, the portions of cooker 100 can be sealed against water/air and can be fully submersed for periods of time in the cooking container with the fluid being heated by the device.

In some embodiments, upper portion 102 can include controller 142. Controller 142 can be a processor for controlling the operation of cooker 100. In some embodiments, controller 142 can be an integrated circuit chip. Controller 142 can be coupled to display device 140 (also housed within upper portion 102) which can display information (e.g., the temperature of the fluid the fluid container, the throughput of intake and ejection ports, the speed at which an impeller is rotating, cooking times, recipe instructions, time remaining, etc.). Upper portion 102 can also include an input device (e.g., coupled to controller 142) to operate cooker 100 (e.g., one or more buttons, scroll wheels, or controls that can enable a user to operate the device). For example, the input device select a temperature for the water in which the lower portion is at least partially immersed, set time, select settings, etc. In at least one embodiment, the input device can include physical buttons and/or virtual buttons rendered on display device 140. The buttons or input controls can include capacitive touch pads to enable user interaction without the need for a full touch screen.

Upper portion 102 can also include a rotation mechanism 104 and tilt mechanism 106. Rotation mechanism 104 can be coupled to display device 140 and can enable display device 140 to be rotated 360 degrees. Rotation mechanism 104 can enable rotation of display device 140 in either the clock-wise or counter clock-wise direction. Tilt mechanism 106 can be coupled to display device 140. Tilt mechanism 106 can enable display device 140 to tilt forwards and backwards (e.g., for better viewing of display device 140).

Upper portion 102 can also include a wireless communication interface (not shown) coupled to controller 142. In some embodiments, controller 142 of circulator cooker 100 can communicatively coupled to a remotely located device (e.g., a smartphone, a server, a tablet, a Personal Computer (PC), temperature sensor, pH sensor, or other electronic device) by the wireless communication interface (e.g., WIFI, Bluetooth, Near Field Communication (NFC), short-range wireless or other similar system capable of sending and receiving data). For example, the wireless communication interface can receive a pH level of the water bath or a temperature of the water bath from a remote sensor. The wireless communication interface can transmit the received data to controller 142 that can control components of cooker 100 to respond to the received data (e.g., actuate heater 124, motor 112, etc.).

In some embodiments, the wireless communication interface can also communicate with a cooling system configured to cool the water bath to refrigerate food items to be cooked at a later time. In other embodiments, a user can enable a cooling system by the inputs of display device 140. The cooling system can cool the fluid of the fluid container to predetermined temperature to adequately and safely store food items (e.g., predetermined temperatures can be based on the food items). For example, cooker 100 can receive instructions (e.g., by an input device or wireless communication interface) to have the food item prepared by a specific time (e.g., 6:30 PM) and that the food item is currently in the fluid of the fluid container. In response, cooker 100 can communication with the cooling system to cool the fluid of the fluid container to an adequate temperature based on the type of food item (e.g., meat, vegetable, combination, etc.) and a current temperature reading of the fluid. When cooker 100 determines it is time to cook the food items (e.g., for completion at 6:30 PM), cooker 100 can send a terminate signal to the cooling system. In response to receiving the terminate signal, cooling system can terminate operation.

In some embodiments, middle portion 108 can include housing for motor and heater base 112. In some embodiments, middle portion 108 is integrated into upper portion 102 or lower potion 110. In some embodiments, middle portion 120 can enclose motor and heater base 112 connected to electric heaters 124. Middle portion 120 can also include a fan (not shown) to blow out any steam that may be present within cooker 100. In some embodiments, the middle portion can have two adjustable electrodes (not shown) coupled to controller 142 and configured to sense the water level of a container. The lengths of the electrodes can be adjustable to enable detection of different water levels. For example, the electrodes can be configurable with attachments that enable adjustment of a length of the electrodes. In some embodiments, middle portion 108 can also be coupled to mounting device 130 enabling attachment of the circulator cooker 100 to a container, or the like.

Mounting device 130 can be configured to releasably secure circulator cooker 100 to a pot, or any container holding a fluid (e.g., water bath). Mounting device 130 can include a collar 132 for attachment to cooker 100. Collar 132 can circumferentially engage with cooker 100. Collar 132 can be positioned at any point along circulator cooker 100 to enable vertical adjustment of cooker 100 immersed in the water bath. Mounting device 130 can also include stationary engagement portion 138 for engaging the inner wall of the container. Mounting device 130 can also include moveable engagement portion 134 coupled to collar 132 by connector 136 and for engaging the outer wall of the container. For example, moveable engagement portion 134 can be a snap clip configured to provide a secure connection to the container. The snap clip is configured in tension with stationary engagement portion 138. When actuated the snap clip is pulled away from stationary engagement portion 138 and the container inserted between stationary engagement portion 138 and the snap clip. When released, snap clip securely and releasably couples collar 132 (i.e., cooker 100) to the container.

In some embodiments, lower portion 110 can be a removable, tool-less screw or clamp-on circulator pump housing or other agitation device housing. Lower portion 110 can be composed of stainless steel or other suitable materials. In one embodiment, lower portion 110 can be a removable clamp-on skirt. Lower portion 110 can include heater 124, drive shaft 114 and impeller 116 (coupled to motor and heater base 112). Lower portion 110 can be configured with one or more liquid intake (flow-in) openings 118. Alternatively, openings 118 can be liquid output (flow-out) openings. In some embodiments, lower portion 110 can be coupled with liquid ejection (flow-out) cap 120 with one or more openings 122, on the side or bottom, through which fluid can pass (as liquid intake (flow-in) or liquid output (flow-out)).

In other embodiments, motor and heater base 112, drive shaft 114, and impeller 116 can be replaced by a submersible pump (located in the lower portion). The submersible pump can draw water in through an inlet and expel water out through an outlet. The submersible pump can also be a refillable pump. For example, the refillable pump can be coupled to a water source (e.g., local water supply of a household). The refillable pump can enable water to flow from the water source into the container housing the water bath. For example, the electrodes of cooker 100 can sense that the water level of the water bath is below the optimal or safe cooking level. In response, controller 142 can notify the refillable water pump to enable water flow from the water source to the water bath. When the electrodes detect a normal operational water level, the refillable pump can stop the water flow.

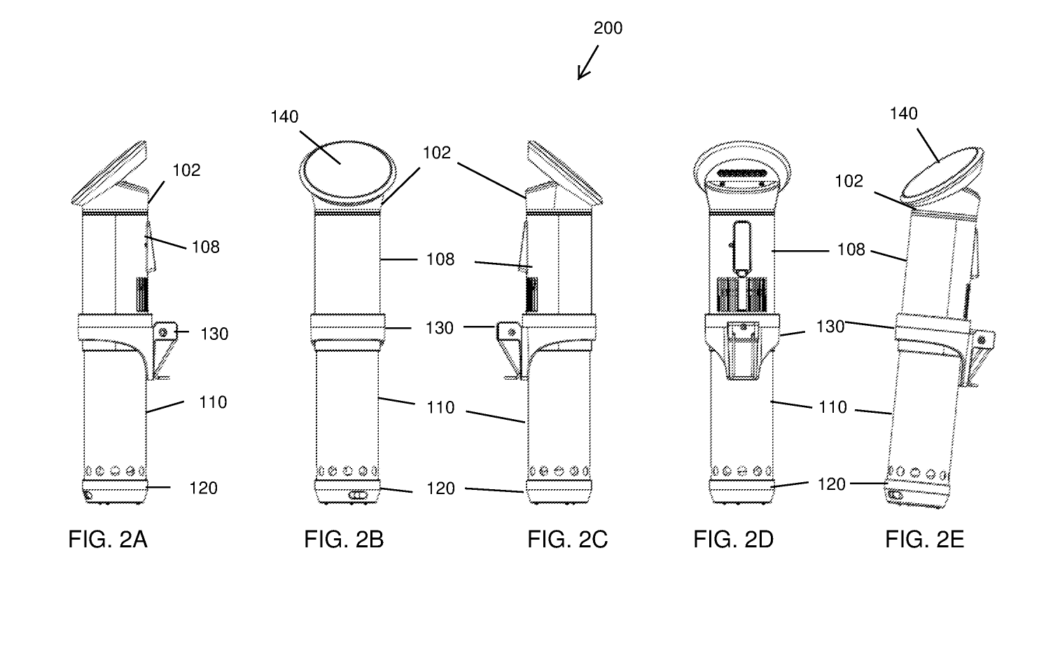

FIGS. 2A-E illustrate a front, back, side and angled view of an example circulator cooker 200.

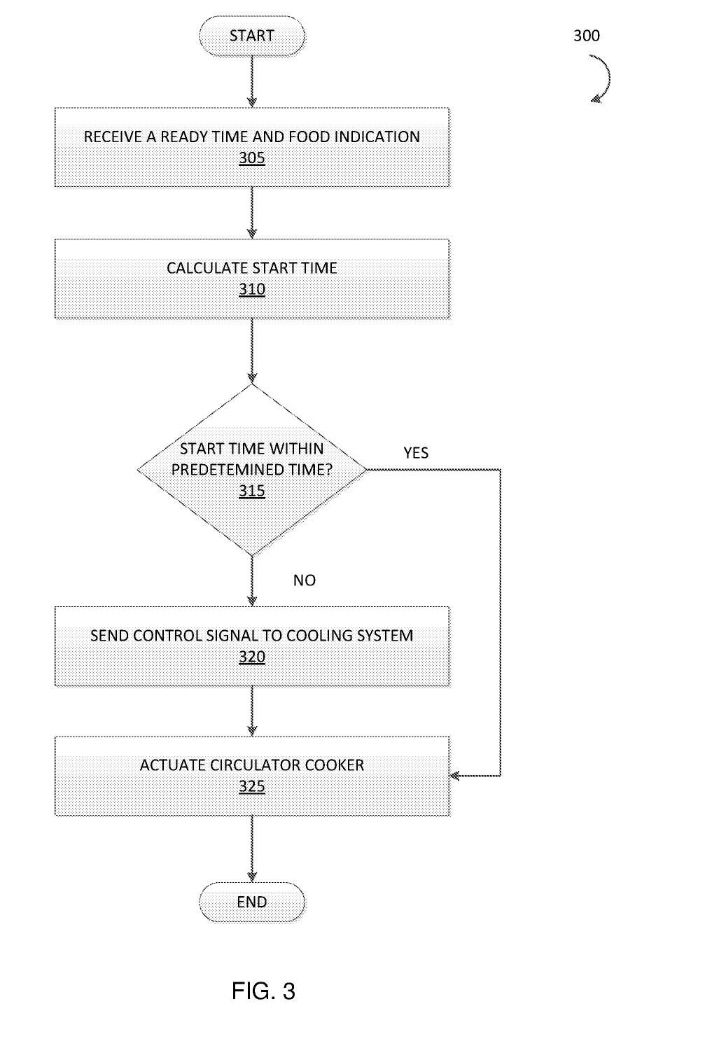

Now turning to FIG. 3, there is shown a method for controlling a circulator cooker and cooling system in accordance with the present technology. The method illustrated in FIG. 3 is provided by way of example, as there are a variety of ways to carry out the method. Additionally, while the example method is illustrated with a particular order of steps, those of ordinary skill in the art will appreciate that FIG. 3 and the steps illustrated therein can be executed in any order that accomplishes the technical advantages of the present disclosure and can include fewer or more steps than illustrated.

Each step shown in FIG. 3 represents one or more processes, methods or subroutines, carried out in example method. The steps illustrated in FIG. 3 can be implemented in a system illustrated in FIG. 1. The flow diagram illustrated in FIG. 3 will be described in relation to and make reference to at least circulator cooker 100 of FIG. 1.

Method 300 can begin at step 305. At step 305, circulator cooker 100 can receive from an input device a ready time and food indication. For example, a user can input a ready time of 6:30 PM (i.e., time the user wishes the food to be done) and that food is current in the container to which the cooker 100 is coupled. In other examples, a food type and other information can also be provided. When circulator cooker 100 has received the input, method 300 can proceed to step 310.

At step 310, circulator cooker 100 can calculate a start time. For example, circulator cooker 100 can calculate a time to start cooking the food in the container. The start time can be calculated based on the type of food and the ready time. In some embodiments, the start time can also be calculated based on a recipe or doneness level. When the start time is calculated, method 300 can proceed to step 315.

At step 315 a determination can be made as to whether the start time is within a predetermined time. In some embodiments, the predetermined time can be based on the food type. For example, if the food type is meat, the predetermined time can be 1 hour. Thus, when the start time is greater than 1 hour, the start time is not within the predetermined time. The predetermined time is determined to ensure safe and proper handling of the food. When the start time is within the predetermined time method 300 can proceed to step 325. When the start time is not within the predetermined time, method 300 can proceed to step 320.

At step 320, circulator cooker 100 can send a control signal to a cooling system. In response to receiving the control signal, the cooling system can actuate to cool the fluid in the container. The cooling system can enable the container to act as a refrigeration unit for safe storage of the food until the start time. In some embodiments, the cooling system can also actuate for a fixed amount of time received with the control signal. In other embodiments, the cooling system will actuate until a terminate signal has been received. In some examples, the cooling system can receive the fluid from the container, cool the fluid and then return the fluid to the container. In other examples, the cooling system can cool the container. When the cooling system has been actuated, method 300 can proceed to step 325.

At step 325, the circulator cooker 100 can actuate to begin cooking of the food. For example, circulator cooker can, at the start time, actuate heater 124 and motor 112. When circulator cooker 100 has actuated, method 300 can end.

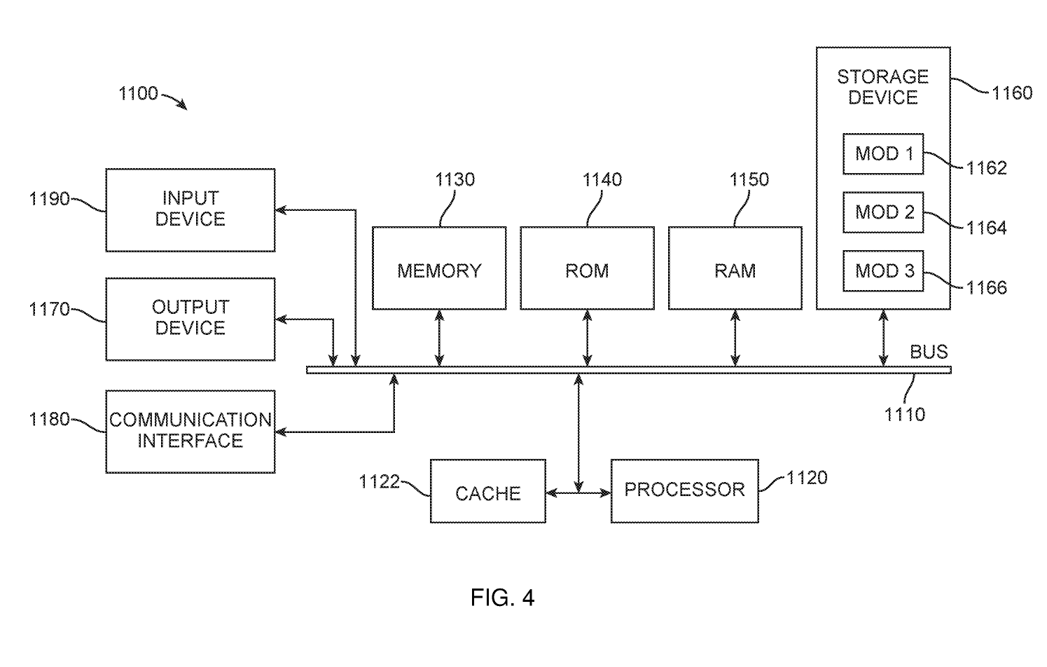

FIG. 4 illustrates control unit 1100 of cooker 100 including a processing unit (for example, a central processing unit (CPU) or processor) 1120 and a system bus 1110 that couples various system components, including the system memory 1130 such as read only memory (ROM) 1140 and random access memory (RAM) 1150, to the processor 1120. The control unit 1100 can include a cache 1122 of high-speed memory connected directly with, in close proximity to, or integrated as part of the processor 1120. The control unit 1100 can copy data from the memory 1130 and/or the storage device 1160 to the cache 1122 for access by the processor 1120. These and other modules can control or be configured to control the processor 1120 to perform various operations or actions. The memory 1130 can include multiple different types of memory with different performance characteristics.

Multiple processors or processor cores can share resources such as memory 1130 or the cache 1122, or can operate using independent resources. The processor 1120 can include one or more of a state machine, an application specific integrated circuit (ASIC), or a programmable gate array (PGA) including a field PGA. The system bus 1110 can be any of several types of bus structures including a memory bus or memory controller, a peripheral bus, and a local bus using any of a variety of bus architectures. A basic input/output (BIOS) stored in ROM 1140 or the like, can provide the basic routine that helps to transfer information between elements within the control unit 1100, such as during start-up.

The control unit 1100 can further include storage devices 1160 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 1160 can include software modules 1162, 1164, 1166 for controlling the processor 1120. The control unit 1100 can include other hardware or software modules. Although the exemplary embodiment(s) described herein employs the hard disk as storage device 1160, other types of computer-readable storage devices which can store data that are accessible by a computer, such as magnetic cassettes, flash memory cards, digital versatile disks (DVDs), cartridges, random access memories (RAMs) 1150, read only memory (ROM) 1140, a cable containing a bit stream and the like can also be used in the exemplary operating environment. Tangible computer-readable storage media, computer-readable storage devices, or computer-readable memory devices, expressly exclude media such as transitory waves, energy, carrier signals, electromagnetic waves, and signals per se.

The basic components and appropriate variations can be modified depending on the type of device, such as whether the control unit 1100 is a small, handheld computing device, a desktop computer, or a computer server. When the processor 1120 executes instructions to perform “operations”, the processor 1120 can perform the operations directly and/or facilitate, direct, or cooperate with another device or component to perform the operations.

To enable user interaction with the control unit 1100, an input device 1190 represents any number of input mechanisms, such as a microphone for speech, a touch-sensitive screen for gesture or graphical input, keyboard, mouse, motion input, scroll wheel, speech and so forth. An output device 1170 can also be one or more of a number of output mechanisms known to those of skill in the art. In some instances, multimodal systems enable a user to provide multiple types of input to communicate with the control unit 1100. The communications interface 1180 generally governs and manages the user input and system output. There is no restriction on operating on any particular hardware arrangement and therefore the basic hardware depicted can easily be substituted for improved hardware or firmware arrangements as they are developed.

One or more parts of the example control unit 1100, up to and including the entire control unit 1100, can be virtualized. For example, a virtual processor can be a software object that executes according to a particular instruction set, even when a physical processor of the same type as the virtual processor is unavailable.

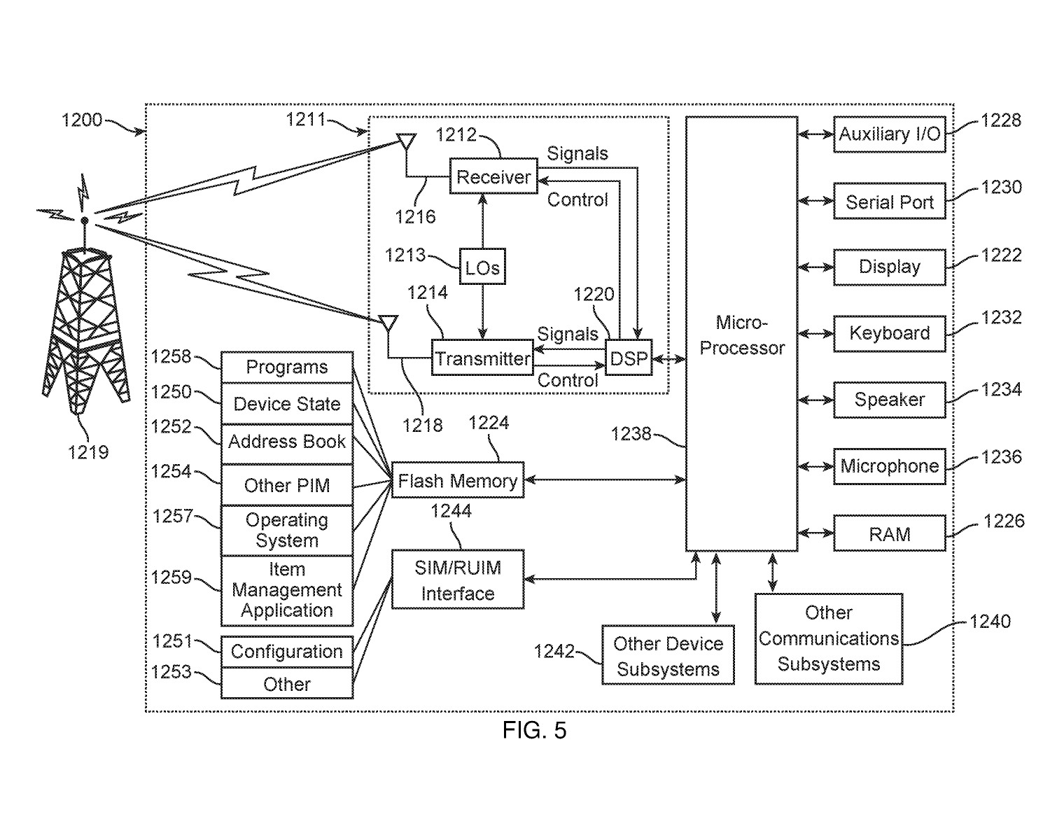

FIG. 5 is a block diagram illustrating an electronic device for controlling a circulator cooker. Electronic device 1200 can include circulator cooker 100, a sous-vide cooker, components of a sous-vide cooker, an electronic device used to control cooker 100, professional electronic devices 375, and/or client electronic devices 350. Electronic device 1200 includes a microprocessor 1238 that controls the operation of the electronic device 1200. A communication subsystem 1211 performs communication transmission and reception with the wireless network 1219. The microprocessor 1238 can be communicatively coupled with an auxiliary input/output (I/O) subsystem 1228 and/or to a serial port (for example, a Universal Serial Bus port) 1230 which can allow for communication with other devices or systems. A display 1222 can be communicatively coupled to microprocessor 1238 to allow for displaying of information to an user of the electronic device 1200. The electronic device 1200 can include a keyboard, 1231, speaker 1234, a microphone, 1236, random access memory (RAM) 1226, and flash memory 1224, all of which can be communicatively coupled to the microprocessor 1238. Other similar components can be provided on the electronic device 1200 as well and optionally communicatively coupled to the microprocessor 1238. Other communication subsystems 1240 and other electronic device subsystems 1242 can be communicatively coupled with the microprocessor 1238. For example, a short range communication system such as BLUETOOTH® communication module or a WI-FI® communication module (a communication module in compliance with IEEE 802.11b). Microprocessor 1238 is configured to perform operating system functions and enables execution of programs on the electronic device 1200. In some implementations not all of the above components can be included in the electronic device 1200. For example, in at least one implementation, the keyboard 1232 is not provided as a separate component and is instead integrated with a touchscreen as described below.

Electronic device 1200 can be equipped with components to enable operation of various programs. In at least one embodiment, flash memory 1224 is enabled to provide a storage location for the operating system 1257, device programs 1258, Address book 1252, PIM 1254 and item management application 1259. The operating system 1257 is generally configured to manage programs 1258 that are also stored in memory 1224 and executable on the microprocessor 1238. The operating system 1257 is configured to service requests made by programs 1258 through predefined program 1258 interfaces. More specifically, the operating system 1257 typically determines the order in which multiple programs 1258 are executed on the microprocessor 1238 and the execution time allotted for each program 1258, manages the sharing of memory 1224 among multiple programs 1258, handles input and output to and from other device subsystems 1242. In addition, users can typically interact directly with the operating system 1257 through a user interface shown on display screen 1222. In at least one embodiment, the operating system 1257 is stored in flash memory 1224; the operating system 1257 in other implementations is stored in read-only memory (ROM) or similar storage element (not shown). As those skilled in the art will appreciate, the operating system 1257, device program 1258 or parts thereof can be loaded in RAM 1226 or other volatile memory.

Electronic device 1200 can be enabled for two-way communication within the wireless communication network 1219. The electronic device 1200 can send and receive signals from a mobile communication service. Examples of communication systems enabled for two-way communication include, but are not limited to, the General Packet Radio Service (GPRS) network, the Universal Mobile Telecommunication Service (UMTS) network, the Enhanced Data for Global Evolution (EDGE) network, the Code Division Multiple Access (CDMA) network, High-Speed Packet Access (HSPA) networks, Universal Mobile Telecommunication Service Time Division Duplexing (UMTS-TDD), Ultra Mobile Broadband (UMB) networks, Worldwide Interoperability for Microwave Access (WiMAX), and other networks that can be used for data and voice, or just data or voice. For the systems listed above, the electronic device 1200 can use a unique identifier to enable the electronic device 1200 to transmit and receive signals from the communication network 1219. Other systems can operate without such identifying information. GPRS, UMTS, and EDGE use a smart card such as a Subscriber Identity Module (SIM) in order to allow communication with the communication network 1219. Likewise, most CDMA systems use a Removable User Identity Module (RUIM) in order to communicate with the CDMA network. A smart card can be used in multiple different electronic devices 1200. The electronic device 1200 can perform some operations without a smart card, but the electronic device 1200 cannot be able to communicate with the network 1219. A smart card interface 1244 located within the electronic device 1200 can enable the removal or insertion of a smart card (not shown). The smart card features memory and holds key configurations 1251, and other information 1253 such as identification and subscriber related information.

Electronic device 1200 can be enabled to both transmit and receive information from the communication network 1219. In order to enable communication with the network 1219, the electronic device 1200 can be equipped with an integral or internal antenna 1218 for transmitting signals to the communication network 1219. Electronic device 1200 can be equipped with antenna 1216 for receiving communication from the communication network 1219. Antennas (1216, 1218) in another embodiment can be combined into a single antenna. As one skilled in the art would appreciate, the antenna or antennae (1216, 1218) in another implementation are externally mounted on the electronic device 1200.

Communication subsystem 1211 can be configured to support the operational needs of the electronic device 1200. The subsystem 1211 includes a transmitter 1214 and receiver 1212 including the associated antenna or antennae (1216, 1218) as described above, local oscillators (LOs) 1213, and a processing module 1220 for example a digital signal processor (DSP).

Communication between the electronic device 1200 and wireless network 1219 can be any type of communication that both the wireless network 1219 and electronic device 1200 are enabled to transmit, receive and process. In general, the communication can be classified as voice and data. Voice communication generally refers to communication in which signals for audible sounds are transmitted by the electronic device 1200 through the communication network 1219. Data generally refers to all other types of communication that the electronic device 1200 is capable of performing within the constraints of the wireless network 1219.

The keyboard 1232 can include a plurality of keys that can be physical buttons or the plurality of keys can be of a software nature, typically constituted by virtual representations of physical keys on the display screen 1222 (referred to herein as “virtual keys”). The user input can be provided as a combination of the two types of keys. Each key of the plurality of keys can have at least one action which can be the input of indicia such as a character, a command or a function. “Characters” are contemplated to exemplarily include alphabetic letters, language symbols, numbers, punctuation, insignias, icons, pictures, and even a blank space.

In the case of virtual keys, the indicia for the respective keys are shown on the display screen 1222, which in one implementation is enabled by touching the display screen 1222, for example, with a stylus, finger, or other pointer, to generate the character or activate the indicated command or function. Some examples of display screens 1222 capable of detecting a touch include resistive, capacitive, projected capacitive, infrared and surface acoustic wave (SAW) touchscreens.

Physical and virtual keys can be combined in many different ways as appreciated by those skilled in the art. In one implementation, physical and virtual keys are combined such that the plurality of enabled keys for a particular program or feature of the electronic device 1200 is shown on the display screen 1222 in the same configuration as the physical keys. Using the configuration just described, the operator can select the appropriate physical key corresponding to what is shown on the display screen 1222. Thus, the desired character, command or function is obtained by depressing the physical key corresponding to the character, command or function displayed at a corresponding position on the display screen 1222, rather than touching the display screen 1222.

While the above description generally describes the systems and components associated with a handheld electronic device, the electronic device 1200 could be another electronic device such as a PDA, a laptop computer, desktop computer, a server, or other electronic device. The electronic device 1200 can comprise different components or the above system might be omitted in order to provide the desired electronic device 1200. Additionally, other components not described above can be used to allow the electronic device 1200 to function in a desired fashion. The above description provides only general components and additional components can be used to enable the system to function. The additional systems and components would be appreciated by those of ordinary skill in the art

The term “comprising”, which is synonymous with “including,” “containing,” or “characterized by” is inclusive or open-ended and does not exclude additional, unrecited elements or method steps. “Comprising” is a term of art used in claim language which means that the named elements are present, but other elements can be added and still form a construct or method within the scope of the claim.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, 1180, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as can be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, CIFS, and AppleTalk™. The network can be, for example, a local area network, a wide-area network, a virtual private network, the Internet, an intranet, an extranet, a public switched telephone network, an infrared network, a wireless network, and any suitable combination thereof.

In embodiments utilizing a Web server, the Web server can run any of a variety of server or mid-tier applications, including HTTP servers, FTP servers, CGI servers, data servers, Java servers, and business application servers. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, or TCL, as well as combinations thereof. The server(s) can also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information can reside in a storage-area network (“SAN”) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system can also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device.

Embodiments of the present disclosure can be provided as a computer program product including a non-transitory machine-readable storage medium having stored thereon instructions (in compressed or uncompressed form) that can be used to program a computer (or other electronic device) to perform processes or methods described herein. The machine-readable storage medium can include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments can also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software can be via Internet download.

Based on the disclosure and teachings provided herein, it will be understood that other ways and methods of implementing the various embodiments described above are possible. The specification and drawings are illustrative and are not to be construed as limiting the scope of the following claims.

1. A circulator cooker comprising:
an upper portion including a rotatable and tiltable display device and a communication interface coupled to a controller;
a lower portion partial immersed in a fluid of a fluid container and having a motor and a heating element coupled to the motor;
the controller configured to receive by the communication interface a temperature reading, and in response actuate the motor and the heating element to heat the fluid of the fluid container to a constant temperature.

2. The circulator cooker of claim 1, wherein the display device can be rotated 360 degrees.

3. The circulator cooker of claim 1, wherein the display device can be rotated in a counter-clockwise direction.

4. The circulator cooker of claim 1, wherein the display device can be rotated in a clockwise direction.

5. The circulator cooker of claim 1, wherein the display device can be tilted in the forward direction.

6. The circulator cooker of claim 1, wherein the display device can be tilted in the backwards direction.

7. The circulator cooker of claim 1, wherein the wireless communication interface can send control signals to a cooling system coupled to the fluid container, the cooling system configured to cool the fluid of the fluid container.

8. The circulator cooker of claim 1, further comprising an audio output device configured to output an audible alert.

9. The circulator cooker of claim 1, wherein the wireless communication interface can transmit to and receive data from a wireless temperature sensor.

10. The circulator cooker of claim 1, wherein the wireless communication interface can transmit to and receive data from a wireless pH sensor.

11. The circulator cooker of claim 1, further comprising an agitation device and impeller coupled to the motor.

12. The circulator cooker of claim 1, wherein the display device can include capacitive touch pads.

13. The circulator cooker of claim 1, further comprising a snap clip coupled to the lower portion and configured to releasably couple the lower portion to the fluid container.

14. The circulator cooker of claim 1, further comprising a submersible pump coupled to the motor.

15. The circulator cooker of claim 14, wherein the submersible pump includes a nozzle and flow diffuser.

16. The circulator cooker of claim 1, wherein the submersible pump is a refillable pump.

17. A circulator cooking system comprising:
a circulator cooker including:
an upper portion including a rotatable and tiltable display device and a communication interface coupled to a controller;
a lower portion partial immersed in a fluid of a fluid container and having a motor and a heating element coupled to the motor;
the controller configured to receive by the communication interface a temperature reading, and in response actuate the motor and the heating element to heat the fluid of the fluid container to a constant temperature; and
a cooling system coupled to the circulator cooker and configured to cool the fluid of the fluid container.

18. A method of sous-vide cooking, the method comprising:
receiving, at a circulator cooker, a ready time and an indication food is present in a fluid of a container;
calculating a start time based on the ready time and a type of food;
transmitting to a cooling system, a control signal to cool the fluid of the container when the start time is not within a predetermined time; and
actuating, at the start time, a heater and an agitation device of the circulator cook.
